(19) United States
(12) Patent Application Publication
(10) Pub. No.: US 2026/0291129 A1
(43) Pub. Date: Sep. 24, 2026

(54) FITTING DETERMINATION DEVICE, FITTING DETERMINATION METHOD, AND NON-TRANSITORY STORAGE MEDIUM STORING FITTING DETERMINATION PROGRAM

(71) Applicant: TOYOTA JIDOSHA KABUSHIKI KAISHA, Toyota-shi (JP)

(72) Inventor: Kenji OJIMA, Nagoya-shi (JP)

(73) Assignee: TOYOTA JIDOSHA KABUSHIKI KAISHA, Toyota-shi (JP)

(21) Appl. No.: 19/541,592

(22) Filed: Feb. 17, 2026

(30) Foreign Application Priority Data
Mar. 21, 2025 (JP) 2025-046312

(51) Int. Cl. H01R 13/641; H01R 13/64

(52) U.S. Cl. CPC H01R 13/641; H01R 13/64

(57) ABSTRACT

A fitting determination device includes: an acquisition unit that acquires a detection result from at least one sensor that detects a physical quantity related to fitting work of fitting a connector; a work determination unit that determines using the detection result whether or not the fitting work is being performed; and a fitting determination unit that, if it is determined that the fitting work is being performed, determines a fitting state of the connector using the detection result.

### CROSS REFERENCE TO RELATED APPLICATIONS

This application claims priority to Japanese Patent Application No. 2025-046312, filed Mar. 21, 2025, the disclosure of which is incorporated by reference herein in its entirety.

### BACKGROUND

### Field

The present disclosure relates to a fitting determination device, a fitting determination method, and a non-transitory storage medium storing a fitting determination program.

### Related Art

There is known a technique of determining whether or not a connector has fitted, using a vibration waveform of a sound and a vibration waveform of a hand (e.g., JP 2022-175941 A).

Patent Literature 1: JP 2022-175941 A

According to the conventional technique, even in a situation that work of fitting a connector is not performed, in other words, a situation that the connector cannot fit, it may be determined due to, for example, surrounding noise that the connector has fitted.

### SUMMARY

According to one aspect of the present disclosure, a fitting determination device is provided. This fitting determination device includes: an acquisition unit configured to acquire a detection result from at least one sensor for detecting a physical quantity related to fitting work of fitting a connector; a work determination unit configured to determine using the detection result whether or not the fitting work is being performed; and a fitting determination unit configured to determine a fitting state of the connector using the detection result when it is determined that the fitting work is being performed.

### BRIEF DESCRIPTION OF THE DRAWINGS

FIG. 1 is a conceptual view illustrating a fitting determination system according to a first embodiment;

FIG. 2 is an explanatory view schematically illustrating a configuration of the fitting determination system according to the first embodiment;

FIG. 3 is a flowchart illustrating a procedure of fitting determination processing according to the first embodiment;

FIG. 4 is a flowchart illustrating a procedure of work determination processing according to the first embodiment;

FIG. 5 is a conceptual view illustrating the fitting determination system according to a second embodiment;

FIG. 6 is an explanatory view schematically illustrating the configuration of the fitting determination system according to the second embodiment;

FIG. 7 is a flowchart illustrating the procedure of the work determination processing according to the second embodiment;

FIG. 8 is a conceptual view illustrating the fitting determination system according to a third embodiment;

FIG. 9 is an explanatory view schematically illustrating the configuration of the fitting determination system according to the third embodiment; and

FIG. 10 is a flowchart illustrating the procedure of the work determination processing according to the third embodiment.

### DETAILED DESCRIPTION

### A. First Embodiment

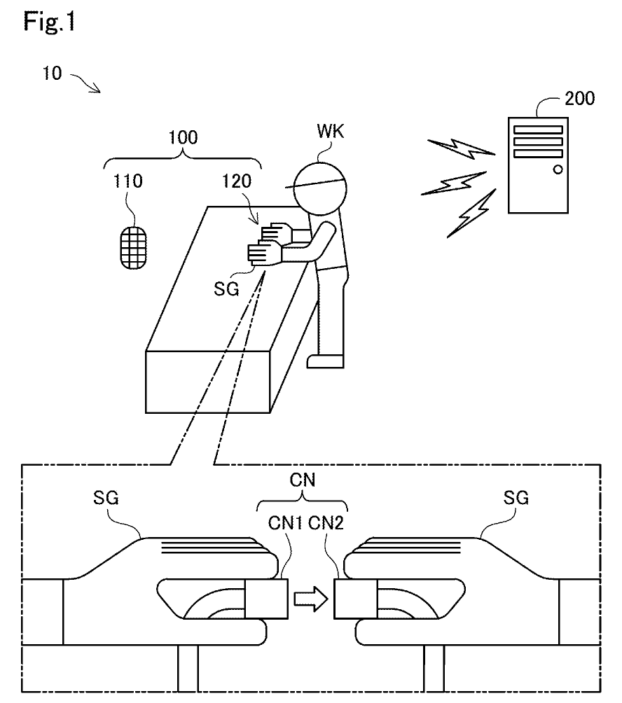

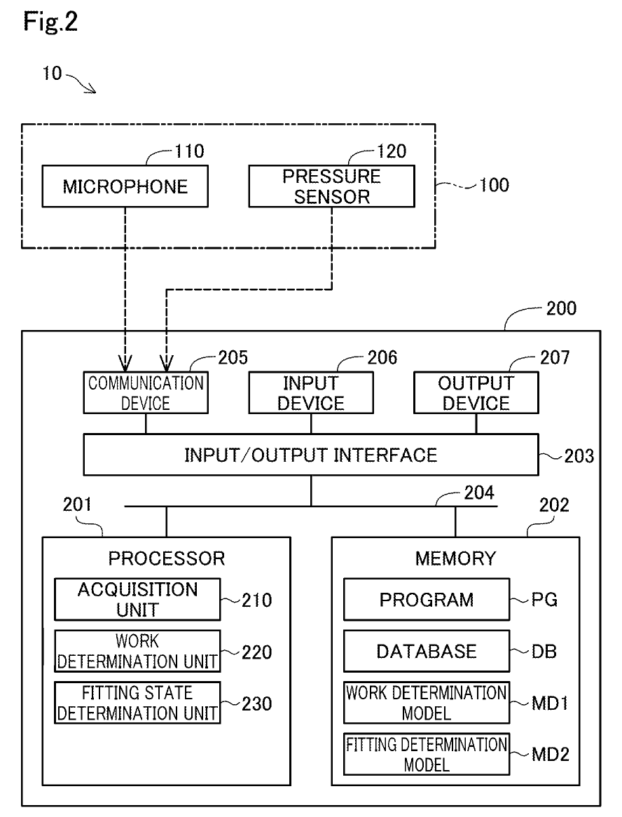

FIG. 1 is a conceptual view of a fitting determination system 10 including a fitting determination device 200 according to the first embodiment. FIG. 2 is an explanatory view schematically illustrating a configuration of the fitting determination system 10. In the present embodiment, as illustrated in FIG. 1, the fitting determination system 10 is used to determine a fitting state of a connector CN at a car manufacturing factory. In this regard, the fitting determination system 10 may be used to determine the fitting state of the connector CN at other than the car manufacturing factory.

The connector CN includes a pair of a male connector CN1 and a female connector CN2. The connector CN is provided with a lock mechanism. The lock mechanism includes, for example, a claw that is provided to one of the male connector CN1 and the female connector CN2, and a groove that is provided to the other one of the male connector CN1 and the female connector CN2 and in which the claw is caught. When the male connector CN1 is fully inserted into the female connector CN2, the lock mechanism works to firmly fix the male connector CN1 and the female connector CN2. When the lock mechanism works, a clicking sound and a click reaction force are produced from the connector CN.

The fitting state of the connector CN includes perfect fitting and half fitting. Perfect fitting refers to a state where the male connector CN1 is inserted into the female connector CN2 and the lock mechanism is working. In a case of perfect fitting, the male connector CN1 and the female connector CN2 are electrically connected. Half fitting refers to a state where the male connector CN1 is inserted into the female connector CN2, yet the lock mechanism is not working. In a case of half fitting, the male connector CN1 and the female connector CN2 may be electrically connected or may not be electrically connected. Perfect fitting refers to an appropriate fitting state, and half fitting refers to an inappropriate fitting state. Half fitting is not preferable because the male connector CN1 is readily detached from the female connector CN2.

As illustrated in FIG. 2, the fitting determination system 10 includes a sensor group 100 and the fitting determination device 200. The sensor group 100 includes at least one sensor that detects a physical quantity related to fitting work of fitting the connector CN. In the present embodiment, the sensor group 100 includes a microphone 110 and a pressure sensor 120.

The microphone 110 is used to detect a sound produced during fitting work. In the present embodiment, the microphone 110 is fixed to a work place at which the fitting work is performed. The fitting work is performed by a worker WK. The microphone 110 is connected to the fitting determination device 200 by wired communication or wireless communication. A detection result of the microphone 110 is transmitted to the fitting determination device 200 in real time by wired communication or wireless communication.

The pressure sensor 120 is used to detect a pressure applied to the fingers of the worker WK during the fitting work. In the present embodiment, the pressure sensors 120 are provided to sensor globes SG attached to the hands of the worker WK. The sensor globe SG is provided with a communication device (not illustrated) that communicates with the fitting determination device 200 by wireless communication. The pressure sensor 120 is connected to the fitting determination device 200 by wireless communication. A detection result of the pressure sensor 120 is transmitted to the fitting determination device 200 in real time by wireless communication.

The fitting determination device 200 is configured as a computer. The fitting determination device 200 includes a processor 201, a memory 202, an input/output interface 203, and an internal bus 204. The processor 201 includes, for example, a CPU and a GPU. The memory 202 includes, for example, a ROM and a RAM. The processor 201, the memory 202, and the input/output interface 203 are connected bidirectionally communicably via the internal bus 204. In the present embodiment, the fitting determination device 200 further includes a communication device 205, an input device 206, and an output device 207. The communication device 205, the input device 206, and the output device 207 are connected to the input/output interface 203. The communication device 205 communicates with each sensor of the sensor group 100 by wired communication or wireless communication. Examples of the input device 206 include a mouse, a keyboard, and the like. Examples of the output device 207 include a display.

The processor 201 functions as an acquisition unit 210, a work determination unit 220, and a fitting determination unit 230 by executing a fitting determination program PG that is a computer program stored in advance in the memory 202. The acquisition unit 210 acquires the detection result from the sensor group 100. In the present embodiment, the acquisition unit 210 acquires the detection result of the microphone 110 and the detection result of the pressure sensor 120.

The work determination unit 220 determines whether or not the fitting work is being performed. In the memory 202, a work determination model MD1 that can determine whether or not the fitting work is being performed is stored in advance. The work determination unit 220 determines whether or not the fitting work is being performed, using the work determination model MD1. In the present embodiment, the work determination model MD1 is a machine learning model that is trained in advance to output a determination result indicating whether or not the fitting work is being performed when the detection results of the microphone 110 and the pressure sensor 120 included the sensor group 100 are input. To train the work determination model MD1, a training data set including the detection results of the microphone 110 and the pressure sensor 120 acquired as a result of a test conducted in advance, and a correct label associated with each detection result can be used. The correct label expresses, for example, whether or not the fitting work is being performed. In this regard, the work determination model MD1 may be not the machine learning model, but a rule base model or a model obtained by combining the machine learning model and the rule base model.

The fitting determination unit 230 determines the fitting state of the connector CN. In the memory 202, a fitting determination model MD2 that can determine the fitting state of the connector CN is stored in advance. In the present embodiment, the fitting determination model MD2 is a machine learning model that is trained in advance to output the fitting state of the connector CN when the detection results of the microphone 110 and the pressure sensor 120 included in the sensor group 100 are input. To train the fitting determination model MD2, a training data set including the detection results of the microphone 110 and the pressure sensor 120 acquired as a result of a test conducted in advance, and a correct label associated with each detection result can be used. The correct label expresses, for example, whether or not the fitting state of the connector CN is perfect fitting. In this regard, the fitting determination model MD2 may be not the machine learning model, but a rule base model or a model obtained by combining the machine learning model and the rule base model.

In the memory 202, a database DB is stored. The database DB includes connector information and work posture information. The connector information indicates a type of the connector CN. When the type of the connector CN differs, at least one of the dimension and a material of the connector CN differs. When the type of the connector CN differs, at least one of a clicking sound and a click reaction force produced at the time of perfect fitting differs. The work posture information indicates a type of a work posture of, for example, fitting the connector CN from above, fitting the connector CN from below, or fitting the connector CN from the front. When the work posture differs, at least one of a clicking sound and a click reaction force differs. In the present embodiment, in the memory 202, a plurality of the work determination models MD1 and a plurality of the fitting determination models MD2 are stored in advance per combination of the connector information and the work posture information. The optimal work determination model MD1 and fitting determination model MD2 are indicated per combination of the connector information and the work posture information in the database DB.

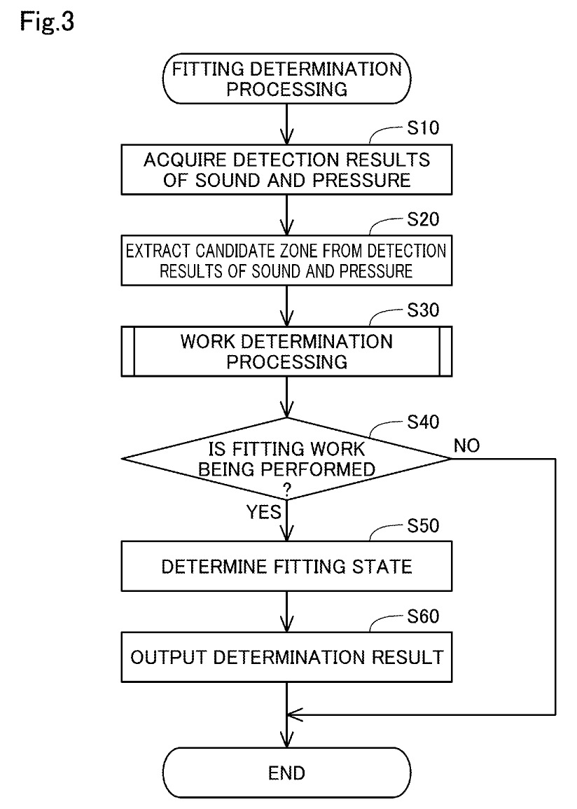

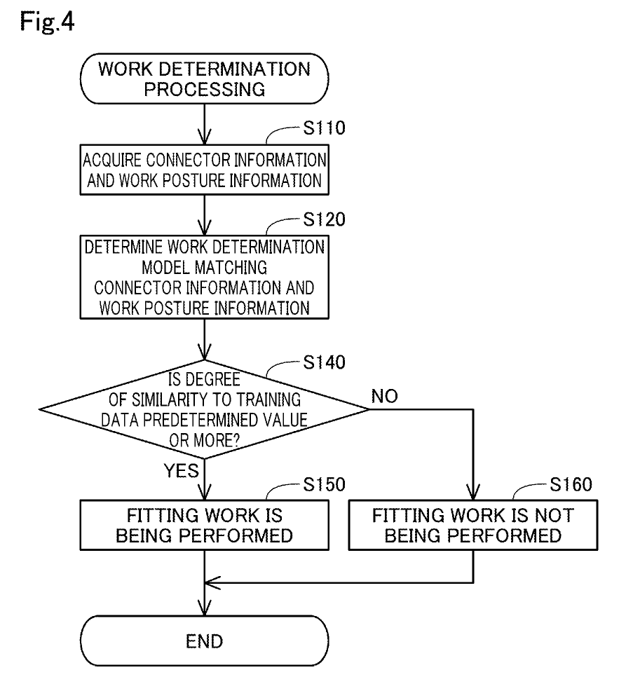

FIG. 3 is a flowchart illustrating a procedure of fitting determination processing. FIG. 4 is a flowchart illustrating a procedure of work determination processing. The fitting determination processing is repeatedly executed at a predetermined cycle by the fitting determination device 200. The fitting determination processing is started when, for example, the worker WK performs a predetermined start operation on the fitting determination device 200 via the input device 206. The work determination processing is executed by the fitting determination device 200 during the fitting determination processing. Note that a method to be executed during the fitting determination processing will be referred to as a fitting determination method, and a method to be executed during the work determination processing will be referred to as a work determination method.

As illustrated in FIG. 3, when the fitting determination processing is started, the acquisition unit 210 acquires the detection result of the microphone 110 and the detection result of the pressure sensor 120 in step S10. In the present embodiment, the detection result of the microphone 110 is time-series data of a sound pressure, and the detection result of the pressure sensor 120 is time-series data of a pressure.

In step S20, the acquisition unit 210 extracts time-series data of a candidate zone from the detection result of the microphone 110 and the detection result of the pressure sensor 120. In the present embodiment, the acquisition unit 210 extracts a zone of a time zone during which a sound of a predetermined frequency has been detected by the microphone 110 as a candidate zone from the time-series data of the sound pressure and the time-series data of the pressure. Time synchronization for the time-series data of the sound pressure and the time-series data of the pressure is performed.

In step S30, the work determination unit 220 executes the work determination processing illustrated in FIG. 4. In the present embodiment, when the work determination processing is started, the work determination unit 220 acquires the connector information and the work posture information in step S110. In the present embodiment, the work determination unit 220 acquires the connector information and the work posture information selected in advance by the worker WK via a selection screen displayed on the output device 207. By operating the input device 206, the worker WK can select the connector information and the work posture information from candidates of the connector information and the work posture information displayed on the selection screen. By, for example, referring to a work manual, the worker WK can grasp the connector information and the work posture information that need to be selected.

In step S120, the work determination unit 220 determines the work determination model MD1 that matches a combination of the connector information and the work posture information. In the present embodiment, by referring to the database DB stored in advance in the memory 202, the work determination unit 220 determines the work determination model MD1 that matches the combination of the connector information and the work posture information.

In step S130, the work determination unit 220 determines whether or not the degree of similarity of the time-series data of the sound pressure and the pressure of a candidate zone, and time-series data of a sound pressure and a pressure included in training data of the work determination model MD1 is a predetermined value or more. The work determination unit 220 inputs the time-series data of the sound pressure and the pressure in the candidate zone as input data to the work determination model MD1. The work determination model MD1 outputs a determination result indicating that the fitting work is being performed if the degree of similarity of the input data and the training data is the predetermined value or more, and outputs a determination result indicating that the fitting work is not being performed if the degree of similarity of the input data and the training data is less than the predetermined value.

If the determination result indicating that the fitting work is being performed is output from the work determination model MD1 in step S130, in other words, if the degree of similarity of the input data and the training data is the predetermined value or more, the work determination unit 220 determines in step S140 that the fitting work is being performed. By contrast with this, if the determination result indicating that the fitting work is not being performed is output from the work determination model MD1 in step S130, in other words, if the degree of similarity of the input data and the training data is less than the predetermined value, the work determination unit 220 determines in step S150 that the fitting work is not being performed. Subsequently, the work determination unit 220 ends the work determination processing, and moves processing to step S40 of the fitting determination processing.

As illustrated in FIG. 3, in step S40 of the fitting determination processing, the fitting determination device 200 determines whether or not the determination result of the work determination processing is the determination result indicating that the fitting work is being performed. If it is determined that the determination result of the work determination processing is not the determination result indicating that the fitting work is being performed, the fitting determination device 200 skips step S40 and subsequent steps, and ends the fitting determination processing. By contrast with this, if it is determined that the determination result of the work determination processing is the determination result indicating that the fitting work is being performed, the fitting determination device 200 moves the processing to step S50.

In step S50, the fitting determination unit 230 determines the fitting state of the connector CN. In the present embodiment, the fitting determination unit 230 determines the fitting state of the connector CN using the time-series data of the sound pressure and the pressure in the candidate zone and the fitting determination model MD2. In the present embodiment, by referring to the database DB, the fitting determination unit 230 determines the fitting determination model MD2 that matches the combination of the connector information and the work posture information from the plurality of fitting determination models MD2 stored in the memory 202, and determines the fitting state of the connector CN using the determined fitting determination model MD2. The fitting determination unit 230 inputs the time-series data of the sound pressure and the pressure in the candidate zone as input data to the fitting determination model MD2. The fitting determination model MD2 outputs a determination result indicating that the fitting state is perfect fitting if the degree of similarity of the input data and the training data is the predetermined value or more, and outputs a determination result indicating that the fitting state is not perfect fitting if the degree of similarity of the input data and the training data is less than the predetermined value.

In step S60, the fitting determination unit 230 outputs the determination result of the fitting state. In the present embodiment, the fitting determination unit 230 causes the output device 207 to display the determination result of the fitting state. In this regard, the fitting determination unit 230 may cause, for example, a smart glass worn by the worker WK or a mobile terminal carried by the worker WK to display the determination result of the fitting state. Thereafter, the fitting determination device 200 ends the fitting determination processing. The fitting determination device 200 repeats the fitting determination processing at a predetermined cycle until the worker WK performs a predetermined end operation. Note that the time-series data of the sound pressure and the pressure used for determination may be assigned a correct label by, for example, an administrator of the fitting determination system 10 or the worker WK, and used for re-training of the work determination model MD1 and the fitting determination model MD2. Re-training makes it possible to further enhance determination accuracy of the work determination model MD1 and the fitting determination model MD2.

According to the fitting determination system 10 according to the above-described present embodiment, the fitting determination device 200 determines the fitting state of the connector CN only when it is determined that the fitting work is being performed. Accordingly, it is possible to suppress erroneous determination due to noise or the like at the work place that the connector CN has fitted even in a situation that the connector CN cannot fit.

Furthermore, in the present embodiment, the fitting determination device 200 determines the work determination model MD1 used for determination from the plurality of work determination models MD1 according to a combination of a connector type and a work posture. Accordingly, it is possible to enhance the degree of accuracy of determination on whether or not the fitting work is being performed. In addition, the fitting determination device 200 determines the fitting determination model MD2 used for determination from the plurality of fitting determination models MD2 according to the combination of the connector type and the work posture. Accordingly, it is possible to enhance the degree of accuracy of determination on the fitting state.

Furthermore, if the degree of similarity of input data and training data is a predetermined value or more, the work determination model MD1 outputs a determination result indicating that the fitting work is being performed. Accordingly, it is possible to suppress erroneous determination that the fitting work is being performed even when the fitting work is not actually being performed. In addition, if the degree of similarity of the input data and the training data is the predetermined value or more, the fitting determination model MD2 outputs a determination result indicating that the fitting state is perfect fitting. It is possible to suppress erroneous determination that the fitting state is perfect fitting even when the fitting state is not actually perfect fitting.

### B. Second Embodiment

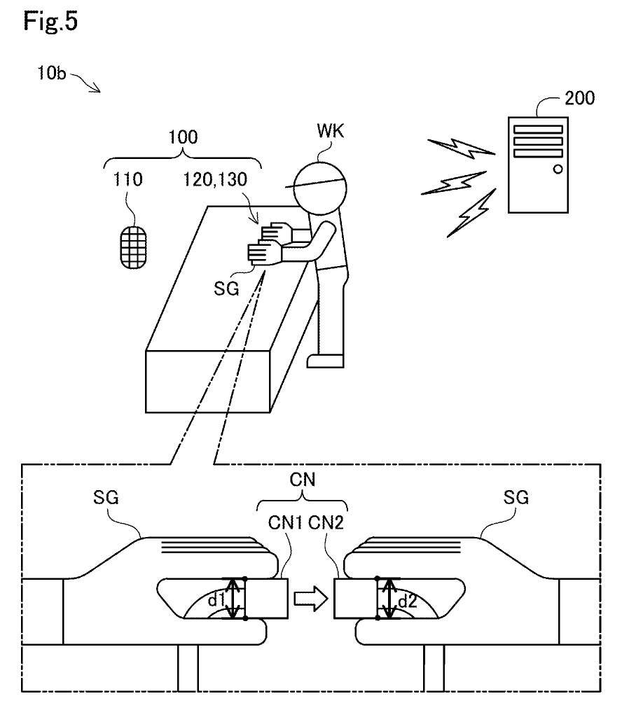

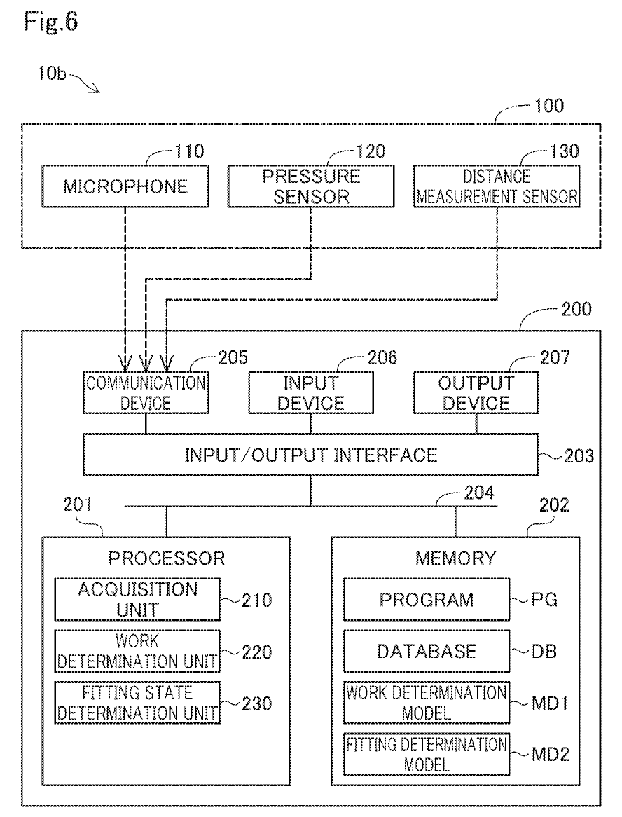

FIG. 5 is a conceptual view of a fitting determination system 10b including the fitting determination device 200 according to the second embodiment. FIG. 6 is an explanatory view schematically illustrating a configuration of the fitting determination system 10b. The second embodiment differs from the first embodiment in the fitting determination system 10b including a distance measurement sensor 130 that detects an interval between the fingers of the worker WK, and contents of the work determination processing executed by the fitting determination system 10b. The other points are the same as those in the first embodiment unless otherwise specified.

In the present embodiment, as illustrated in FIG. 6, the sensor group 100 includes the distance measurement sensor 130. As illustrated in FIG. 5, the distance measurement sensor 130 is provided to the sensor globe SG. In the present embodiment, the distance measurement sensor 130 detects intervals d1 and d2 between fingertips of thumbs and index fingers that hold the connector CN. In the following description, an interval between fingertips will be referred to as a fingertip interval. In the present embodiment, the distance measurement sensor 130 is an ultrasonic-type distance measurement sensor. The distance measurement sensor 130 includes an ultrasonic oscillator that is provided to one of a thumb portion and an index finger portion of the sensor globe SG, and an ultrasonic receiver that is provided to the other one. In this regard, the distance measurement sensor 130 is not limited to the ultrasonic-type distance measurement sensor, and may be an optical-type distance measurement sensor or may be a radio wave-type distance measurement sensor that uses a millimeter wave or the like. A detection result of the distance measurement sensor 130 is transmitted to the fitting determination device 200 in real time by wireless communication.

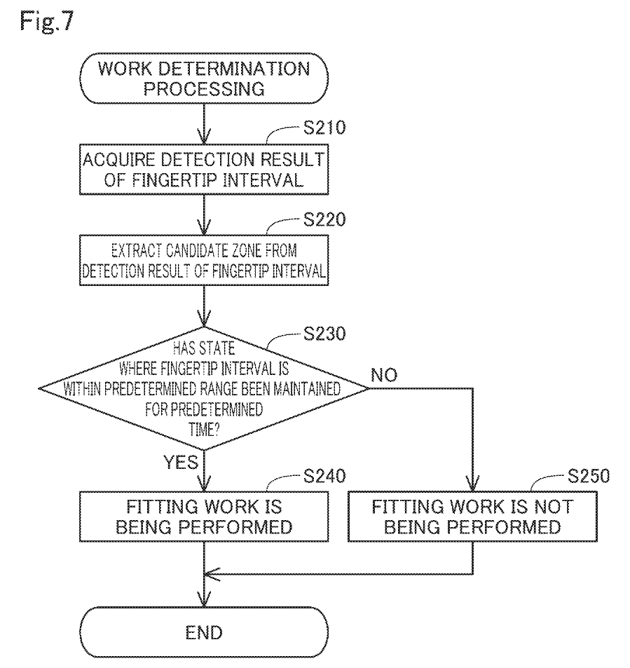

FIG. 7 is a flowchart illustrating a procedure of work determination processing executed by the fitting determination system 10b. The work determination processing is executed by the fitting determination device 200 during the fitting determination processing. In the present embodiment, when the work determination processing is started, the acquisition unit 210 acquires the detection result of the distance measurement sensor 130 in step S210. In the present embodiment, the detection result of the distance measurement sensor 130 is time-series data of a distance.

In step S220, the acquisition unit 210 extracts time-series data of a candidate zone from the detection result of the distance measurement sensor 130. In the present embodiment, the acquisition unit 210 extracts a zone of a time zone during which a sound of a predetermined frequency has been detected by the microphone 110 as the candidate zone from the time-series data of the distance. Time synchronization for the time-series data of the sound pressure acquired by the microphone 110, the time-series data of the pressure acquired by the pressure sensor 120, and the time-series data of the distance acquired by the distance measurement sensor 130 is performed.

In step S230, the work determination unit 220 determines whether or not a state where the fingertip intervals d1 and d2 are within a predetermined range has been maintained for a predetermined time. In the present embodiment, the work determination unit 220 determines whether or not the state where the fingertip intervals d1 and d2 are within the predetermined range has been maintained for the predetermined time, using the time-series data of the distance in the candidate zone and the work determination model MD1. The work determination model MD1 outputs a determination result indicating that fitting work is being performed if the state where the fingertip intervals d1 and d2 detected by the distance measurement sensor 130 are within the predetermined range has been maintained for the predetermined time, and outputs a determination result indicating that the fitting work is not being performed if the state where the fingertip intervals d1 and d2 detected by the distance measurement sensor 130 are within the predetermined range has not been maintained for the predetermined time.

In a case of work of pinching the connector CN by the left hand alone, the work determination model MD1 determines whether or not the fitting work is being performed, using the fingertip interval d1 of the left hand. In a case of work of pinching the connector CN by the right hand alone, the work determination model MD1 determines whether or not the fitting work is being performed, using the fingertip interval d2 of the right hand. When the connector CN is pinched by the left and right hands, the work determination model MD1 preferably determines whether or not the fitting work is being performed, using the fingertip intervals d1 and d2 of the left and right hands. In this case, the work determination model MD1 may determine that the fitting work is being performed only if determination results of both of the left and right hands are determination results indicating that the fitting work is being performed. In this regard, the work determination model MD1 may determine that the fitting work is being performed if the determination result of one of the left and right hands is a determination result indicating that the fitting work is being performed.

If the determination result indicating that the fitting work is being performed is output from the work determination model MD1 in step S230, in other words, if the state where the fingertip intervals d1 and d2 are within the predetermined range has been maintained for the predetermined time, the work determination unit 220 determines in step S240 that the fitting work is being performed. By contrast with this, if the determination result indicating that the fitting work is not being performed is output from the work determination model MD1 in step S230, in other words, if the state where the fingertip intervals d1 and d2 are within the predetermined range has not been maintained for the predetermined time, the work determination unit 220 determines in step S250 that the fitting work is not being performed. Subsequently, the work determination unit 220 ends the work determination processing, and moves processing to step S40 of the fitting determination processing.

According to the fitting determination system 10b according to the above-described present embodiment, the fitting determination device 200 determines whether or not the fitting work is being performed, using the fingertip intervals d1 and d2. Consequently, it is possible to enhance the degree of accuracy of determination on whether or not the fitting work is being performed. In the present embodiment in particular, the fitting determination device 200 determines that the fitting work is being performed only if the state where the fingertip intervals d1 and d2 are within the predetermined range has been maintained for the predetermined time, and consequently can effectively enhance the degree of accuracy of determination on whether or not the fitting work is being performed.

### C. Third Embodiment

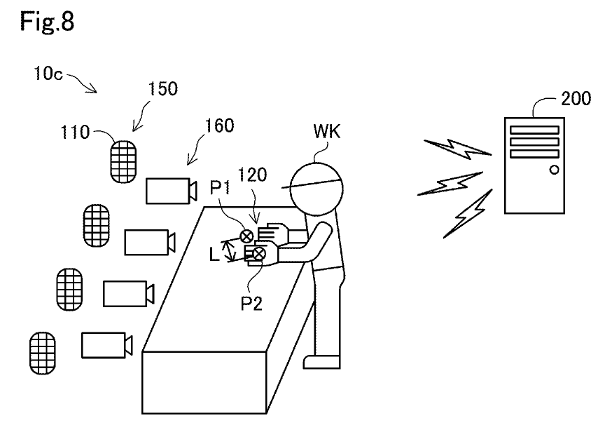

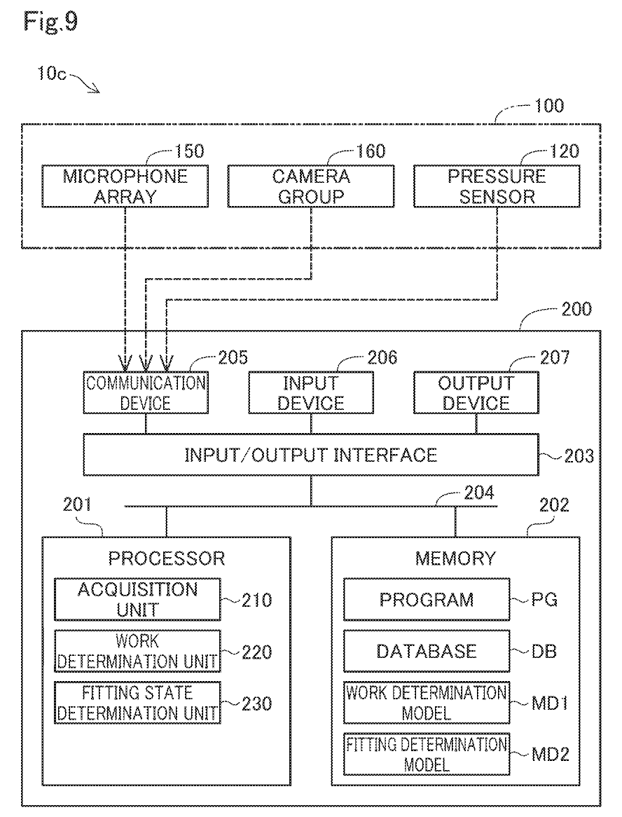

FIG. 8 is a conceptual view of a fitting determination system 10c including the fitting determination device 200 according to the third embodiment. FIG. 9 is an explanatory view schematically illustrating a configuration of the fitting determination system 10c. The third embodiment differs from the first embodiment in the fitting determination system 10c including a microphone array 150 and a camera group 160, and contents of the work determination processing executed by the fitting determination system 10c. The other points are the same as those in the first embodiment unless otherwise specified.

The microphone array 150 includes a plurality of the microphones 110. The microphone array 150 is fixed to a work place. In the present embodiment, the plurality of microphones 110 included in the microphone array 150 are aligned in line and disposed. The microphone array 150 detects a position P1 of a sound source. The position P1 of the sound source is expressed by X, Y, and Z coordinates of a predetermined reference coordinate system.

The camera group 160 includes at least one camera. Each camera included in the camera group 160 is fixed to the work place. In the present embodiment, the camera is an infrared camera. In this regard, the camera is not limited to the infrared camera, and may be, for example, a visible light camera. The camera group 160 detects a position P2 of the hand of the worker WK. Note that, in another embodiment, instead of the hand of the worker WK, a position of part of the body other than the hand of the worker WK may be detected. Alternatively, the camera group 160 may detect the position of the connector CN instead of the position of part of the body of the worker WK. The position of the microphone array 150 and the position of the camera group 160 are adjusted in advance, and the position P2 of the hand is expressed by X, Y, and Z coordinates in the above reference coordinate system.

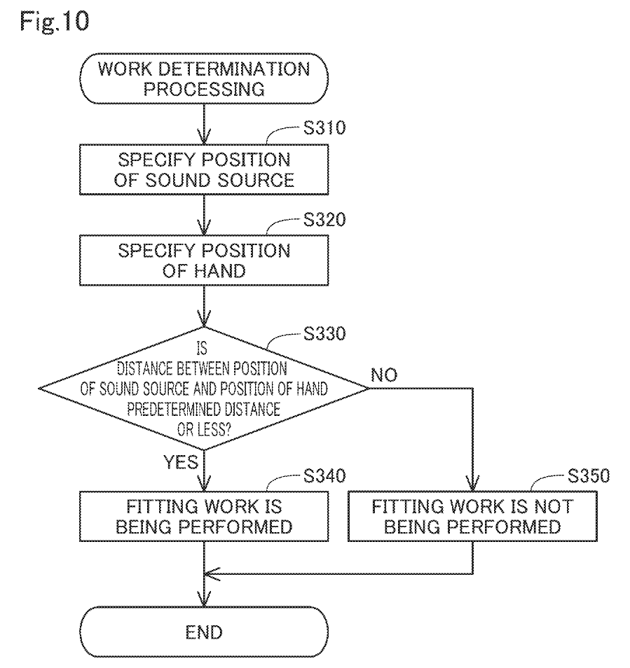

FIG. 10 is a flowchart illustrating a procedure of work determination processing executed by the fitting determination system 10c. The work determination processing is executed by the fitting determination device 200 during the fitting determination processing. In the present embodiment, when the work determination processing is started, the acquisition unit 210 acquires the detection result of the microphone array 150, and specifies the position P1 of the sound source from the detection result of the microphone array 150 in step S310.

In step S320, the acquisition unit 210 acquires the detection result of the camera group 160, and specifies the position P2 of the hand of the worker WK from the detection result of the camera group 160. The acquisition unit 210 specifies the position P2 of the hand at a time at which a sound has been produced from the sound source.

In step S330, the work determination unit 220 determines whether or not a distance L between the position P1 of the sound source and the position P2 of the hand is within a predetermined range. In the present embodiment, the work determination unit 220 determines whether or not the distance L between the position P1 of the sound source and the position P2 of the hand is within the predetermined range, using the detection result of the microphone array 150, the detection result of the camera group 160, and the work determination model MD1. The work determination model MD1 outputs a determination result indicating that the fitting work is being performed when the distance L between the position P1 of the sound source and the position P2 of the hand is within the predetermined range, and outputs a determination result indicating that the fitting work is not being performed when the distance L between the position P1 of the sound source and the position P2 of the hand is outside the predetermined range.

If the determination result indicating that the fitting work is being performed is output from the work determination model MD1 in step S330, in other words, when the distance L between the position P1 of the sound source and the position P2 of the hand is within the predetermined range, the work determination unit 220 determines in step S340 that the fitting work is being performed. By contrast with this, if the determination result indicating that the fitting work is not being performed is output from the work determination model MD1 in step S330, in other words, when the distance L between the position P1 of the sound source and the position P2 of the hand is within the predetermined range, the work determination unit 220 determines in step S350 that the fitting work is not being performed. Subsequently, the work determination unit 220 ends the work determination processing, and moves processing to step S40 of the fitting determination processing.

According to the fitting determination system 10c according to the above-described present embodiment, the fitting determination device 200 determines that the fitting work is being performed only when the distance L between the position P1 of the sound source detected by the microphone array 150 and the position P2 of the hand detected by the camera group 160 is within the predetermined range, and consequently can enhance the degree of accuracy of determination on whether or not the fitting work is being performed.

### D. Other Embodiment

(D1) In each of the above embodiments, the sensor group 100 includes the pressure sensor 120 provided to the sensor globe SG. By contrast with this, the sensor group 100 may include an acceleration sensor provided to the sensor globe SG instead of the pressure sensor 120 or in addition to the pressure sensor 120. In this case, it is possible to execute at least one of determination on whether or not the fitting work is being performed and determination on the fitting state of the connector CN using time-series data of an acceleration acquired by the acceleration sensor.

(D2) In the above second embodiment, the work determination unit 220 determines that the fitting work is being performed if the state where the fingertip intervals d1 and d2 detected by the distance measurement sensor 130 are within the predetermined range has been maintained for the predetermined time, and determines that the fitting work is not being performed if the state where the fingertip intervals d1 and d2 detected by the distance measurement sensor 130 are within the predetermined range has not been maintained for the predetermined time. By contrast with this, the work determination unit 220 may determine that the fitting work is being performed when the fingertip intervals d1 and d2 detected by the distance measurement sensor 130 are within the predetermined range irrespectively of a time during which the state where the fingertip intervals d1 and d2 detected by the distance measurement sensor 130 are within the predetermined range has been maintained, and determine that the fitting work is not being performed when the fingertip intervals d1 and d2 detected by the distance measurement sensor 130 are outside the predetermined range.

The present disclosure is not limited to the above-described embodiments, and can be implemented by various configurations without departing from the gist of the present disclosure. For example, technical features in the embodiments can be replaced or combined as appropriate to solve part or all of the above-described problems or achieve part or all of the above-described effects. Furthermore, the technical features that are not described as indispensable in this description can be deleted as appropriate. The patent disclosure may be implemented by aspects described below.

(1) A first aspect according to the present disclosure provides a fitting determination device. This fitting determination device includes: an acquisition unit configured to acquire a detection result from at least one sensor for detecting a physical quantity related to fitting work of fitting a connector; a work determination unit configured to determine using the detection result whether or not the fitting work is being performed; and a fitting determination unit configured to determine a fitting state of the connector using the detection result when it is determined that the fitting work is being performed.

According to the fitting determination device according to this aspect, it is possible to suppress erroneous determination that the connector has fitted even in a situation that the connector cannot fit.

(2) In the fitting determination device according to the above aspect, the work determination unit may determine whether or not the fitting work is being performed, using the detection result and a degree of similarity to a physical quantity related to the fitting work and acquired in advance.

The fitting determination device according to this aspect can enhance the degree of accuracy of determination on whether or not the fitting work is being performed.

(3) In the fitting determination device according to the above aspect, the at least one sensor may include a distance measurement sensor for detecting an interval between fingers of a worker who pinches the connector, and the work determination unit may determine whether or not the fitting work is being performed, using the interval between the fingers.

The fitting determination device according to this aspect determines whether or not the fitting work is being performed, using the interval between the fingers, and consequently can enhance the degree of accuracy of determination on whether or not the fitting work is being performed.

(4) In the fitting determination device according to the above aspect, if a state where the interval between the fingers is within a predetermined range has been maintained for a predetermined time, the work determination unit may determine that the fitting work is being performed.

The fitting determination device according to this aspect determines that the fitting work is being performed when the state where the interval between the fingers is within the predetermined range has been maintained for the predetermined time, and consequently can enhance the degree of accuracy of determination on whether or not the fitting work is being performed.

(5) In the fitting determination device according to the above aspect, the at least one sensor may include a microphone array for detecting a position of a sound source, and a camera for detecting a position of a hand of the worker who pinches the connector or a position of the connector, and when a distance between the position of the sound source and the position of the hand or the connector is within a predetermined range, the work determination unit may determine that the fitting work is being performed.

The fitting determination device according to this aspect determines that the fitting work is being performed when the distance between the position of the sound source and the position of the hand or the connector is within the predetermined range, and consequently can enhance the degree of accuracy of determination on whether or not the fitting work is being performed.

(6) A second aspect according to the present disclosure provides a fitting determination method. This fitting determination method includes the steps of: acquiring a detection result from at least one sensor for detecting a physical quantity related to fitting work of fitting a connector; determining using the detection result whether or not the fitting work is being performed; and determining a fitting state of the connector using the detection result when it is determined that the fitting work is being performed.

According to the fitting determination method according to this aspect, it is possible to suppress erroneous determination that the connector has fitted even in a situation that the connector cannot fit.

(7) A third aspect according to the present disclosure provides a non-transitory storage medium storing a fitting determination program. This fitting determination program causes a computer to implement: a function of acquiring a detection result from at least one sensor for detecting a physical quantity related to fitting work of fitting a connector; a function of determining using the detection result whether or not the fitting work is being performed; and a function of determining a fitting state of the connector using the detection result when it is determined that the fitting work is being performed.

According to the fitting determination program according to this aspect, it is possible to suppress erroneous determination that the connector has fitted even in a situation that the connector cannot fit.

The present disclosure can be also implemented as various aspects other than the fitting determination device, the fitting determination method, and the non-transitory storage medium storing a fitting determination program. For example, the present disclosure can be implemented as, for example, aspects such as a fitting determination system.

What is claimed is:

1. A fitting determination device comprising:
an acquisition unit configured to acquire a detection result from at least one sensor for detecting a physical quantity related to fitting work of fitting a connector;
a work determination unit configured to determine using the detection result whether or not the fitting work is being performed; and
a fitting determination unit configured to determine a fitting state of the connector using the detection result when it is determined that the fitting work is being performed.

2. The fitting determination device according to claim 1, wherein the work determination unit determines whether or not the fitting work is being performed, using the detection result and a degree of similarity to a physical quantity related to the fitting work and acquired in advance.

3. The fitting determination device according to claim 1, wherein
the at least one sensor includes a distance measurement sensor for detecting an interval between fingers of a worker who pinches the connector, and
the work determination unit determines whether or not the fitting work is being performed, using the interval between the fingers.

4. The fitting determination device according to claim 3, wherein, if a state where the interval between the fingers is within a predetermined range has been maintained for a predetermined time, the work determination unit determines that the fitting work is being performed.

5. The fitting determination device according to claim 1, wherein
the at least one sensor includes a microphone array for detecting a position of a sound source, and a camera for detecting a position of a hand of a worker who pinches the connector or a position of the connector, and
when a distance between the position of the sound source and the position of the hand or the connector is within a predetermined range, the work determination unit determines that the fitting work is being performed.

6. A fitting determination method comprising:
acquiring a detection result from at least one sensor for detecting a physical quantity related to fitting work of fitting a connector;
determining using the detection result whether or not the fitting work is being performed; and
determining a fitting state of the connector using the detection result when it is determined that the fitting work is being performed.

7. A non-transitory storage medium storing a fitting determination program causing a computer to implement:
a function of acquiring a detection result from at least one sensor for detecting a physical quantity related to fitting work of fitting a connector;
a function of determining using the detection result whether or not the fitting work is being performed; and
a function of determining a fitting state of the connector using the detection result when it is determined that the fitting work is being performed.
